(19) United States
(12) Patent Application Publication
(10) Pub. No.: US 2024/0191849 A1
(43) Pub. Date: Jun. 13, 2024

(54) INTELLIGENT LIGHTING FIXTURE WITH EMERGENCY BACKUP SYSTEM

(71) Applicant: E2 Lighting International Inc., Grapevine, TX (US)

(72) Inventor: Michael Kwong, Southlake, TX (US)

(21) Appl. No.: 18/583,913

(22) Filed: Feb. 22, 2024

Related U.S. Application Data
(63) Continuation-in-part of application No. 17/962,195, filed on Oct. 7, 2022.

(51) Int. Cl. F21S 9/02; F21S 8/04; F21V 23/00; F21V 23/04; F21Y 115/10; H05B 47/115; H05B 47/175; H05B 47/19

(52) U.S. Cl. CPC F21S 9/022; F21S 8/043; F21V 23/001; F21V 23/008; F21V 23/0435; F21V 23/0471; H05B 47/115; H05B 47/19; H05B 47/1965; F21Y 2115/10

(57) ABSTRACT

An intelligent lighting fixture having a smart Bluetooth Low Energy (BLE) control sensor system, a sensor for triggering various functions, a programmable control circuit for lighting and control functions, and an emergency battery backup. The smart BLE control sensor system can communicate with a mobile application, allowing the user to control the lighting and control functions of the fixture. The sensor, which can be a motion sensor, triggers the lighting functions based on detected motion. The emergency battery backup automatically powers the fixture in the event of a power outage. The mobile application can also receive sensor data and adjust the lighting functions and control functions based on the received data.

### CROSS-REFERENCE TO RELATED APPLICATIONS

This application is a Continuation-in-Part Utility Patent application claiming priority to U.S. patent application Ser. No. 17/962,195, filed on Oct. 7, 2022, which is incorporated by reference herein in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The present disclosure generally pertains to the field of smart lighting technology, and more specifically, to advanced illumination devices with integrated emergency systems that utilize Bluetooth Low Energy (BLE) control sensor systems.

### Description of Related Art

Lighting fixtures are common devices used to illuminate spaces. They come in various forms such as downlights, spotlights, and floodlights, among others. These fixtures are often powered by a main power supply and may fail to function in the event of a power outage. Therefore, some lighting fixtures are equipped with an emergency battery backup system to ensure continuous operation during power outages.

The emergency lights are commonly used in commercial buildings, hospitals, schools, offices and residential housing. They commonly include a cabinet mounted on a wall or on the bottom surface of a ceiling. The cabinet includes a rechargeable battery and has a light source mounted to the cabinet. The emergency lights serve a useful purpose in having the ability to provide lighting in a power outage, but they are not a welcome addition to a decorated area.

When there is a power outage, current emergency lighting fixture has power to provide lighting for a period of time but do not look aesthetically pleasing, especially given that the lighting fixture and battery are separated and mounted in the interior of a room or space. The current system is complicated for installation and has inconvenient wiring connections. The current set up includes the lighting fixture and the battery pack separated, they need to be rewired before completing an installation set up. This installation process is the most painful process. There is a need for an aesthetically pleasing emergency light which includes a pre-wired battery and lighting fixture for safer and faster installation process.

In particular there is a need for an emergency light fixture which provides lighting and module control and can blend in with a variety of decorative themes.

There is also a need for a slim or low profile downwardly facing light fixture which provides emergency lighting in a power outage or other event including a battery as a rechargeable power source for the system.

There is also a need for a slim or low profile downwardly facing light fixture which combines a compatible battery pack and down light fixture to create an emergency lighting fixture.

There is also a need for a down light fixture and a pre-wired battery with backup capabilities in one metal housing.

There is also a need for a down light fixture and a pre-wired battery with backup that can be controlled wirelessly through a phone app, tablet app or other computer device having wireless capabilities.

There is also a need for a slim or low profile downwardly facing light fixture which saves on labor costs in reducing additional holes in the ceiling for housing the push button. The push button indicator pre-wired into the fixture, preferably on the surface of the downward facing housing.

There is also a need for a slim or low profile downwardly facing light fixture which is decoratively appealing.

### BRIEF SUMMARY OF THE INVENTION

According to an aspect of the present disclosure, an emergency downlight lighting fixture includes a smart BLE (Bluetooth Low Energy) control sensor system, a sensor configured to trigger various functions, a control circuit for lighting functions and control functions, and an emergency battery backup. According to other aspects of the present disclosure, the smart BLE control sensor system may be configured to communicate with a mobile application. The mobile application may be configured to control the lighting functions and control functions of the fixture. The sensor may be a motion sensor configured to trigger the lighting functions based on detected motion. The control circuit may be programmable to customize the lighting functions and control functions. The emergency battery backup may be configured to automatically power the fixture in the event of a power outage and may be rechargeable. According to another aspect of the present disclosure, a lighting fixture includes a smart BLE control sensor system, a sensor configured to trigger various functions, a control circuit for lighting functions and control functions, and an emergency battery backup. The control circuit may be programmable or accessible from a phone app. According to other aspects of the present disclosure, the smart BLE control sensor system may be configured to communicate with a mobile application. The mobile application may be configured to control the lighting functions and control functions of the fixture. The sensor may be a motion sensor configured to trigger the lighting functions based on detected motion. The control circuit may be programmable to customize the lighting functions and control functions. The emergency battery backup may be configured to automatically power the fixture in the event of a power outage and may be rechargeable. According to yet another aspect of the present disclosure, an intelligent lighting fixture includes a smart BLE control sensor system, a sensor configured to trigger various functions, a control circuit for lighting functions and control functions, an emergency battery backup, and a phone app configured to program or access the control circuit. According to other aspects of the present disclosure, the smart BLE control sensor system may be configured to communicate with the phone app to control the lighting functions and control functions of the fixture. The phone app may be configured to receive sensor data from the sensor and adjust the lighting functions and control functions based on the received sensor data. The sensor may be a motion sensor configured to trigger the lighting functions based on detected motion. The control circuit may be programmable via the phone app to customize the lighting functions and control functions. The emergency battery backup may be configured to automatically power the fixture in the event of a power outage and the status of the emergency battery backup may be communicated to the phone app.

The instant invention in one form is directed to an emergency lighting fixture including a light housing having reflective surfaces for providing light in a generally downward direction, the housing mountable to a ceiling surface having low clearance. The emergency lighting fixture includes an LED lamp disposed in the light housing, a control box movable with respect to the light housing, a battery and a control circuit disposed for controlling power flow through the battery and the power flow through the LED lamp. The emergency lighting fixture includes a wire harness electrically connecting the LED lamp through the light housing to the control box, an LED indicator on a bottom surface of the light housing, a cable electrically connecting the control box and the LED lamp in the light housing and a test button disposed on the bottom surface of the light housing. Power is stored in the battery and the battery is in constant electrical connection to the control circuit. When power is supplied to the LED lamp from the control circuit an area is illuminated below the emergency lighting fixture. The LED indicator may be on when the EBBU (Emergency Battery Backup Unit) mode is activated. The LED indicator may flicker slowly when the battery in charging and may flicker quickly when an EBBU (Emergency Battery Backup Unit) error occurs. Depressing the test button may activate the EBBU (Emergency Battery Backup Unit) mode while releasing the test button may revert the mode to AC. The emergency lighting fixture may include a dimmer for reducing the power supplied to the LED lamp. The LED lamp may provide at least 1000 lumens. The emergency lighting fixture may be ETL and ES certified. Power into the LED lamp may be between 5 watts and 30 watts and preferably between 10 watts and 18 watts. The LED lamp color may be between 22K and 60K and preferably between 27K and 50K. The light housing may be constructed of die-cast aluminum. The emergency lighting fixture according to claim 1 wherein the wattage of the LED lamp is tunable.

Another aspect of the present invention is directed to a method for installing an emergency lighting fixture. The method includes providing a light housing having reflective surfaces for providing light in a generally downward direction, the housing mountable to a ceiling surface having low clearance, the emergency lighting system including an LED lamp disposed in the light housing, a control box movable with respect to the light housing, a battery, a control circuit disposed for controlling power flow through the battery and the power flow through the LED lamp, a wire harness electrically connecting the LED lamp through the light housing to the control box, an LED indicator on a bottom surface of the light housing, a cable electrically connecting the control box and the LED lamp in the light housing and a test button disposed on the bottom surface of the light housing wherein power is stored in the battery and the battery is in constant electrical connection to the control circuit and wherein when power is supplied to the LED lamp from the control circuit an area is illuminated below the emergency lighting fixture. The method includes providing an opening in a ceiling where the emergency lighting system is to be installed, wiring a power cable to the emergency lighting system control box, placing the control box in above the ceiling and mounting the light housing in the ceiling opening.

Using smart technology, the lighting fixture includes various smart features. One such feature is the integration of sensors that can trigger various functions. For example, motion sensors can be used to activate the lighting fixture when movement is detected in its vicinity. This can be particularly useful in saving energy as the light is turned on and off based on the presence or absence of people in the room.

Furthermore, the integration of Bluetooth Low Energy (BLE) technology in the lighting fixtures allows wireless communication between the fixture and other devices such as smartphones. BLE is a power-efficient variant of the classic Bluetooth technology, designed for short-range communication between devices. It is particularly suitable for applications that require periodic or intermittent data transfer and is widely used in the field of Internet of Things (IoT) such as the fixture of the present invention.

Control circuits are another integral part of modern lighting fixtures. These circuits manage the operation of the fixture, including lighting functions and control functions. They can be programmed to customize the behavior of the fixture based on various parameters. For instance, the intensity of the light, the color temperature, or the activation and deactivation times can be adjusted according to user preferences.

Mobile applications have also become a common interface for controlling smart devices, including lighting fixtures. These applications can communicate with the fixture via BLE and allow users to control various aspects of the fixture remotely. This can include turning the light on or off, adjusting the brightness, changing the color, and even programming the fixture to operate according to a specific schedule.

Another aspect of the invention as shown in FIG. 1 includes an intelligent lighting fixture having a light housing having reflective surfaces for providing light in a generally downward direction, the light housing mountable to a ceiling surface having a low clearance above the ceiling surface. The intelligent lighting fixture includes an LED lamp disposed in the light housing, a control box movable with respect to the light housing, and a battery disposed in the control box. The intelligent lighting fixture includes a control circuit disposed in the control box for controlling power flow through the battery and the power flow through the LED lamp and a wire harness electrically connecting the LED lamp through the light housing to the control box. Power is stored in the battery and the battery is in constant electrical connection to the control circuit. When power is supplied to the LED lamp from the control circuit an area is illuminated below the emergency lighting fixture. The intelligent lighting fixture includes a sensor configured to trigger lighting functions, a control circuit for lighting functions and control functions and a smart BLE (Bluetooth Low Energy) control sensor system integrated into the control circuit. The control circuit is programmable or accessible from a mobile device. In one embodiment, the smart BLE control sensor system is configured to communicate with the mobile device through a mobile application. The mobile application is configured to control the lighting functions and control functions of the fixture. The sensor is a motion sensor configured to trigger the lighting functions based on detected motion. The control circuit is programmable to customize the lighting functions and control functions. The intelligent lighting fixture includes an emergency battery backup system configured to automatically power the LED in the event of a power outage. The emergency battery backup is rechargeable.

Another aspect of the invention as shown in FIG. 1 is an intelligent lighting fixture including a smart BLE (Bluetooth Low Energy) control sensor system, a sensor configured to trigger various functions, a control circuit for lighting functions and control functions, an emergency battery backup and a phone app configured to program or access the control circuit. The smart BLE control sensor system is configured to communicate with the phone app to control the lighting functions and control functions of the fixture. The phone app is configured to receive sensor data from the sensor and adjust the lighting functions and control functions based on the received sensor data. The sensor is a motion sensor configured to trigger the lighting functions based on detected motion. The control circuit is programmable via the phone app to customize the lighting functions and control functions. The emergency battery backup is configured to automatically power the fixture in the event of a power outage and the status of the emergency battery backup is communicated to the phone app.

Another aspect of the invention as shown in FIG. 1 is an emergency downlight lighting fixture, including a smart BLE (Bluetooth Low Energy) control system, a sensor configured to trigger at least one function, a control circuit for lighting control and an emergency battery backup. The smart BLE control sensor system is configured to communicate with a mobile application. The mobile application is configured to control the lighting functions of the fixture. The sensor is a motion sensor configured to trigger the lighting functions based on detected motion. The control circuit is programmable to customize the lighting functions. The emergency battery backup is configured to automatically power the fixture in the event of a power outage. The emergency battery backup is rechargeable.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a bottom plan view of the intelligent lighting fixture according to the present invention;

FIG. 2 is a perspective view of the control box shown in FIG. 1;

FIG. 3 is a bottom plan view showing various sizes of the visible portion of the intelligent lighting fixture;

FIG. 4 shows a typical wiring layout for the intelligent lighting fixture;

FIG. 5 shows a method of mounting the intelligent lighting fixture;

FIG. 6 is a bottom plan view of the visible portion of the intelligent lighting fixture;

FIG. 7 shows a perspective view of a second embodiment of intelligent lighting fixture;

FIG. 8 is bottom plan view of the second embodiment of the intelligent lighting fixture shown in FIG. 7;

FIG. 9 shows a side elevational view of the second embodiment of the intelligent lighting fixture according to the present invention;

FIG. 10 is a bottom plan view of the intelligent lighting fixture shown in FIG. 9;

FIG. 11 shows a bottom plan view of another embodiment of the intelligent lighting fixture according to the present invention;

FIG. 12 is a side elevational view of the intelligent lighting fixture shown in FIG. 11; and

FIG. 13 is a perspective view of yet another embodiment of the intelligent lighting fixture according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms intelligent lighting fixture, exiting emergency down light fixture, emergency light fixture and emergency down light may be used interchangeably to mean an intelligent lighting fixture which illuminates in a generally downward direction, the fixture including a battery backup. Since all embodiments described in this application include the backup battery and intelligent control of the fixture. The term “slim” with respect to the housings refers to the relatively small height of any housing wherein the LED lamp is close to the fixture lens since the space within the housing is limited. “Slim” may apply to any of the housings described herein.

The present disclosure relates to lighting fixtures, and more particularly, to intelligent lighting fixtures that incorporate a smart Bluetooth Low Energy (BLE) control sensor system, a sensor for triggering various functions, a control circuit for lighting and control functions, and an emergency battery backup. These fixtures may be designed for a variety of applications, including but not limited to, residential, commercial, and industrial settings. Rather than using BLE, the smart control sensor system may alternately use wi-fi, Zigbee or any other wireless technology.

In some aspects, the lighting fixture may include a smart BLE control sensor system that enables communication with a mobile application. This communication may allow for remote control of the lighting fixture's functions, providing a user with the ability to customize lighting settings according to their specific requirements. The sensor, which may be a motion sensor in some cases, can trigger lighting functions based on detected motion, enhancing the functionality and convenience of the lighting fixture.

In some cases, the lighting fixture may include a control circuit that is programmable to customize the lighting functions and control functions. This programmability may provide a user with the flexibility to adjust the lighting fixture's operations according to their specific preferences or requirements. Furthermore, the lighting fixture may include an emergency battery backup that can automatically power the fixture in the event of a power outage, ensuring continuous operation and enhancing the reliability of the lighting fixture.

Additionally, the lighting fixture may include a phone app configured to program or access the control circuit. This phone app may communicate with the smart BLE control sensor system to control the lighting functions and control functions of the fixture. In some aspects, the phone app may receive sensor data from the sensor and adjust the lighting functions and control functions based on the received sensor data. This feature may provide a user with real-time control and customization of the lighting fixture's operations.

Overall, the lighting fixtures described herein may provide a variety of technical benefits. For example, the integration of a smart BLE control sensor system and a programmable control circuit may provide enhanced control and customization of the lighting fixture's operations. The inclusion of an emergency battery backup may ensure continuous operation of the lighting fixture in the event of a power outage. Furthermore, the ability to control and customize the lighting fixture's operations via a phone app may provide a user with a convenient and flexible lighting solution.

The emergency downlight lighting fixture may include a smart BLE (Bluetooth Low Energy) control sensor system, a sensor, a control circuit, and an emergency battery backup. The smart BLE control sensor system may be configured to communicate with a mobile application. In some cases, this communication may allow for remote control and monitoring of the lighting fixture. The sensor may be configured to trigger various functions. In some aspects, the sensor may be a motion sensor configured to trigger the lighting functions based on detected motion. This feature may provide automatic lighting in response to detected movement, enhancing the functionality and convenience of the lighting fixture.

The control circuit may be responsible for lighting functions and control functions. In some cases, the control circuit may be programmable to customize the lighting functions and control functions. This programmability may allow for a user to tailor the lighting fixture's operations to their specific requirements or preferences. The emergency battery backup may be configured to automatically power the fixture in the event of a power outage. In some aspects, this feature may ensure continuous operation of the lighting fixture, providing reliable lighting even during power interruptions.

In some aspects, the smart BLE control sensor system may be configured to communicate with a mobile application. This communication may be established and maintained through a variety of methods. For instance, the smart BLE control sensor system may initiate a connection with the mobile application by transmitting a signal that the mobile application can detect and respond to. Once the connection is established, the smart BLE control sensor system and the mobile application may exchange data to facilitate control and monitoring of the lighting fixture.

In some cases, the smart BLE control sensor system may communicate with the mobile application to control the lighting functions and control functions of the fixture. This may involve the smart BLE control sensor system transmitting data related to the current state of the lighting fixture to the mobile application. The mobile application may then process this data and send back commands to the smart BLE control sensor system to adjust the lighting functions and control functions as desired. This feature may provide a user with the ability to remotely control and customize the lighting fixture's operations, enhancing the convenience and flexibility of the lighting solution. The smart control sensor system may alternately use wi-fi, Zigbee or any other wireless technology

In other cases, the smart BLE control sensor system may be configured to communicate with a phone app to control the lighting functions and control functions of the fixture. This communication may be similar to the communication with the mobile application described above. The phone app may receive data from the smart BLE control sensor system, process this data, and send back commands to adjust the lighting functions and control functions. This feature may provide a user with the ability to control and customize the lighting fixture's operations directly from their phone, offering a convenient and user-friendly lighting solution.

In some aspects, the mobile application may be configured to control the lighting functions and control functions of the fixture. This may involve the mobile application receiving data from the smart BLE control sensor system, processing this data, and sending back commands to adjust the lighting functions and control functions. The data received by the mobile application may include information about the current state of the lighting fixture, such as the current lighting intensity, color temperature, or power status. The mobile application may process this data and generate commands based on user input or pre-set preferences. These commands may then be sent back to the smart BLE control sensor system, which may adjust the lighting functions and control functions of the fixture accordingly.

In some cases, the mobile application may also be configured to receive sensor data from the sensor and adjust the lighting functions and control functions based on the received sensor data. For instance, if the sensor is a motion sensor, the mobile application may receive data indicating that motion has been detected. The mobile application may then process this data and send back a command to the smart BLE control sensor system to turn on the light or adjust its intensity. This feature may provide automatic lighting in response to detected movement, enhancing the functionality and convenience of the lighting fixture.

In other cases, a phone app may be configured to control the lighting functions and control functions of the fixture. The phone app may communicate with the smart BLE control sensor system in a similar manner to the mobile application. The phone app may receive data from the smart BLE control sensor system, process this data, and send back commands to adjust the lighting functions and control functions. This feature may provide a user with the ability to control and customize the lighting fixture's operations directly from their phone, offering a convenient and user-friendly lighting solution.

In some aspects, the phone app may also be configured to receive sensor data from the sensor and adjust the lighting functions and control functions based on the received sensor data. For example, if the sensor is a motion sensor, the phone app may receive data indicating that motion has been detected. The phone app may then process this data and send back a command to the smart BLE control sensor system to turn on the light or adjust its intensity. This feature may provide automatic lighting in response to detected movement, enhancing the functionality and convenience of the lighting fixture.

In some aspects, the sensor may be a motion sensor configured to trigger the lighting functions based on detected motion. The motion sensor may be configured to detect movement within a specified range or area. Upon detecting motion, the sensor may send a signal to the control circuit, which may then trigger the lighting functions. This may involve turning on the light, adjusting its intensity, or changing its color temperature, among other possible lighting functions. This feature may provide automatic lighting in response to detected movement, enhancing the functionality and convenience of the lighting fixture.

In other cases, the sensor may be configured to trigger various functions based on detected motion. For instance, the sensor may be configured to trigger not just the lighting functions, but also other control functions of the fixture. This may involve adjusting the power status of the fixture, changing the mode of operation, or activating the emergency battery backup, among other possible control functions. The sensor may be configured to trigger these functions based on specific patterns or levels of detected motion. This feature may provide a user with a more comprehensive and responsive control over the lighting fixture's operations.

Turning to the control circuit, in some aspects, it may be responsible for managing the lighting functions and control functions of the lighting fixture. The control circuit may be programmable, allowing for customization of these functions. For instance, the control circuit may be programmed to adjust the intensity, color temperature, or pattern of the light based on user preferences or specific conditions. This programmability may provide a user with the ability to tailor the lighting fixture's operations to their specific requirements or preferences, enhancing the flexibility and user-friendliness of the lighting solution.

In some cases, the control circuit may be programmable via a phone app. This may involve the phone app sending programming commands to the control circuit through the smart BLE control sensor system. The control circuit may then adjust the lighting functions and control functions based on these commands. For example, the phone app may send a command to the control circuit to adjust the light intensity to a specific level, change the color temperature to a particular value, or activate a specific lighting pattern. The control circuit may then execute these commands, adjusting the lighting functions and control functions accordingly. This feature may provide a user with the ability to customize the lighting fixture's operations directly from their phone, offering a convenient and user-friendly lighting solution.

In other aspects, the control circuit may be programmable to customize the control functions of the lighting fixture. This may involve programming the control circuit to adjust the power status of the fixture, change the mode of operation, or activate the emergency battery backup based on specific conditions or user preferences. This programmability may provide a user with enhanced control over the lighting fixture's operations, enhancing the functionality and convenience of the lighting solution.

Turning to the emergency battery backup, in some aspects, it may be configured to automatically power the fixture in the event of a power outage. This automatic activation may be facilitated by a power detection circuit or similar mechanism that can detect a loss of power supply and trigger the emergency battery backup. Upon activation, the emergency battery backup may supply power to the control circuit, allowing the lighting functions and control functions of the fixture to continue operating despite the power outage. This feature may ensure continuous operation of the lighting fixture, providing reliable lighting even during power interruptions.

In some cases, the emergency battery backup may be rechargeable. This may involve the emergency battery backup being connected to a power source, such as a wall outlet or a solar panel, which can supply power to recharge the battery. The recharging process may be managed by a charging circuit or similar mechanism that can control the flow of power to the battery to ensure safe and efficient recharging. Once fully charged, the emergency battery backup may be ready to provide power to the fixture in the event of another power outage. This rechargeable nature of the emergency battery backup may provide a sustainable and cost-effective solution for ensuring continuous operation of the lighting fixture.

In other aspects, the status of the emergency battery backup may be communicated to the phone app. This may involve the smart BLE control sensor system transmitting data related to the current charge level or operational status of the emergency battery backup to the phone app. The phone app may then display this information to the user, allowing them to monitor the status of the emergency battery backup and plan for its recharging or replacement as necessary. This feature may provide a user with enhanced visibility and control over the emergency battery backup, enhancing the reliability and user-friendliness of the lighting solution.

In some aspects, the phone app may play a pivotal role in programming or accessing the control circuit of the lighting fixture. The phone app may be configured to send programming commands to the control circuit through the smart BLE control sensor system. These commands may be based on user input or pre-set preferences and may instruct the control circuit to adjust the lighting functions and control functions of the fixture. For instance, the phone app may send a command to adjust the light intensity, change the color temperature, or activate a specific lighting pattern. The control circuit may then execute these commands, adjusting the lighting functions and control functions accordingly. This feature may provide a user with the ability to customize the lighting fixture's operations directly from their phone, offering a convenient and user-friendly lighting solution.

In some cases, the phone app may also be configured to receive sensor data from the sensor and adjust the lighting functions and control functions based on the received sensor data. For example, if the sensor is a motion sensor, the phone app may receive data indicating that motion has been detected. The phone app may then process this data and send back a command to the smart BLE control sensor system to turn on the light or adjust its intensity. This feature may provide automatic lighting in response to detected movement, enhancing the functionality and convenience of the lighting fixture.

In some aspects, the emergency battery backup may be configured to automatically power the fixture in the event of a power outage. This automatic activation may be facilitated by a power detection circuit or similar mechanism that can detect a loss of power supply and trigger the emergency battery backup. Upon activation, the emergency battery backup may supply power to the control circuit, allowing the lighting functions and control functions of the fixture to continue operating despite the power outage. This feature may ensure continuous operation of the lighting fixture, providing reliable lighting even during power interruptions.

In other cases, the emergency battery backup may be configured to automatically power the fixture in the event of a power outage and the status of the emergency battery backup may be communicated to the phone app. This may involve the smart BLE control sensor system transmitting data related to the current charge level or operational status of the emergency battery backup to the phone app. The phone app may then display this information to the user, allowing them to monitor the status of the emergency battery backup and plan for its recharging or replacement as necessary. This feature may provide a user with enhanced visibility and control over the emergency battery backup, enhancing the reliability and user-friendliness of the lighting solution.

A number of implementations have been described. Nevertheless, it will be understood that various modifications may be made without departing from the spirit and scope of the disclosure. Accordingly, other implementations are within the scope of the following claims.

The exiting emergency down light fixture is composed emergency battery back and down light fixture. This combination package with emergency battery and light fixture are complicated to wired up and often combining the wrong battery package. This current set up is the lighting fixture and the battery pack are separated, they need to be rewired before completing an installation set up. This installation process is the most painful process. This invention is to alleviate this pain and simplify the installation with simple instruction to save time and save labor. LED ultra slim down light with pre-wired battery and emergency push button indicator. Full metal conduit wiring and combine LED driver and battery backup driver metal housing box.

The exiting emergency down light fixture is a down light with an integrated emergency battery backup and push button indicator, the driver and battery pack in housing preferably constructed of metal, temperature resistant plastic, composite material or any combination thereof.

The exiting emergency down light fixture is more decorative than current emergency lighting fixtures. This invention has a lighting function and an emergency lighting function in one fixture. Saving additional labor installation and material cost. Takes the guess work out of combining compatible battery pack and LED lighting fixture during installation to set up this type of system.

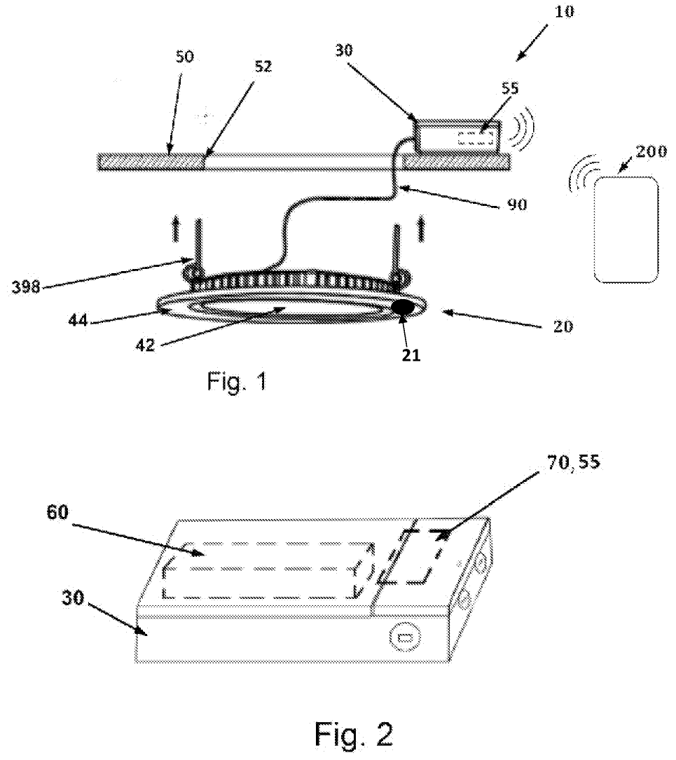

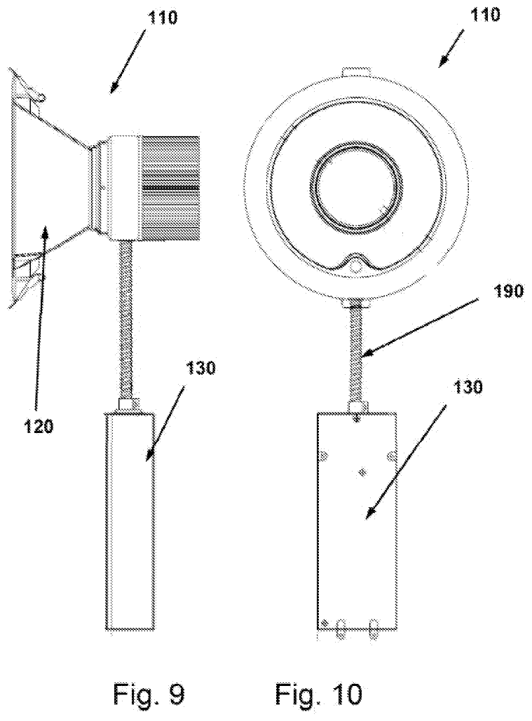

Referring now to the drawings FIGS. 1-13, and more particularly to FIGS. 1 and 2, there is shown the intelligent lighting fixture according to the present invention. The intelligent lighting fixture is an emergency downlight lighting fixture 10 which includes a smart BLE (Bluetooth Low Energy) control system 55, a sensor 21 configured to trigger at least one function and a control circuit for lighting control 70 which may include the smart BLE control sensor. The fixture 10 includes an emergency battery backup 60. The smart BLE control sensor system may be configured to communicate wirelessly with a mobile application on a mobile phone 200 or smart tablet. The mobile application may be configured to control the lighting functions of the fixture. The sensor 21 may be a motion sensor configured to trigger the lighting functions based on detected motion. The control circuit 70 may be programmable to customize the lighting functions. The emergency battery backup may be configured to automatically power the fixture in the event of a power outage. The emergency battery backup may be rechargeable. An enclosure 30 houses the battery backup 60 and the control circuit 70.

Another aspect of the invention is a lighting fixture 10, includes a light housing 20 having reflective surfaces for providing light in a generally downward direction. The light housing 20 is mountable to a ceiling surface having a low clearance above the ceiling surface. The lighting fixture 10 includes an LED lamp 42 disposed in the light housing 20, a control box 30 movable with respect to the light housing 20, a battery 60 disposed in the control box 30 and a control circuit 70 disposed in the control box for controlling power flow through the battery 60 and the power flow through the LED lamp 42. The lighting fixture 10 includes a wire harness 90 electrically connecting the LED lamp through the light housing 20 to the control box 30. Power is stored in the battery 60 and the battery 60 is in constant electrical connection to the control circuit 70. When power is supplied to the LED lamp 52 from the control circuit 70 an area is illuminated below the lighting fixture. The lighting fixture 10 include a smart BLE (Bluetooth Low Energy) control sensor system 55 and a sensor 21 configured to trigger at least one function. The lighting fixture 10 includes a control circuit 70 for lighting functions and control functions and an emergency battery backup, wherein the control circuit 70 is accessible from a phone app on a smart phone 200. The control circuit 70 is programmable from a phone app on a smart phone 200. The smart BLE control sensor system is configured to communicate with a mobile application. The mobile application is configured to control the lighting functions and control functions of the fixture. The sensor 21 may be a motion sensor configured to trigger the lighting functions based on detected motion. The control circuit 70 is programmable to customize the lighting functions and control functions. The emergency battery backup is configured to automatically power the fixture in the event of a power outage. The emergency battery backup may be rechargeable. The smart BLE control sensor system may alternately use wi-fi, Zigbee or any other wireless technology rather than BLE technology.

Another aspect of the invention is an intelligent lighting fixture 10, including a smart BLE (Bluetooth Low Energy) control sensor system 55, a sensor 21 configured to trigger various functions, a control circuit 70 for lighting functions and control functions, an emergency battery backup 90 and a phone app on a smart phone 200 configured to program or access the control circuit 70. The smart BLE control sensor system 70 may be configured to communicate with the phone app to control the lighting functions and control functions of the fixture 10. The phone app may be configured to receive sensor data from the sensor 21 and adjust the lighting functions and control functions based on the received sensor data. The sensor 21 may be a motion sensor configured to trigger the lighting functions based on detected motion. The control circuit 70 is programmable via the phone app to customize the lighting functions and control functions. The emergency battery backup 60 may be configured to automatically power the fixture in the event of a power outage and the status of the emergency battery backup is communicated to the phone app. An event such as a fire, motion, temperature change, time change, alarm trigger may trigger the sensor 21 wherein a notification is sent to the mobile device 200.

In another aspect of the present invention is an emergency lighting fixture 10 shown in FIG. 1. The emergency lighting fixture 10 includes a control box 30 shown in FIG. 2 and a light housing 20 having reflective surfaces for providing light in a generally downward direction, the light housing 20 mountable to a ceiling surface 50, preferable mounted in an opening 52 of the ceiling. The light housing 20 is particularly useful in ceilings having low clearance in the space above the ceiling. The emergency lighting fixture 10 includes an LED lamp 40 disposed in the light housing 20, the control box 30 movable with respect to the light housing 20, a battery 60 and a control circuit 70 disposed in the control box for controlling power flow through the battery and the power flow through the LED lamp. The battery 60 may alternately be located in the light housing 20. The emergency lighting fixture 10 includes a cable or wire harness 90 electrically connecting the LED lamp 40 through the light housing 20 to the control box 30. The emergency lighting fixture 10 includes at least one LED indicator 80 adjacent or on a lens 42 of the light housing 20, the cable 70 electrically connecting a circuit in the control box 30 and the LED lamp 40 in the light housing 20. The emergency lighting fixture 10 includes a test button 84 disposed on the bottom surface of the light housing 20 or adjacent the lens 42 or outer ring 44. Power is stored in the battery 60 and the battery is in constant electrical connection to the control circuit. The emergency lighting fixture 10 may alternately use wi-fi, Zigbee or any other wireless technology. An event such as a fire, motion, temperature change, time change, alarm trigger may trigger the sensor 21 wherein a notification is sent to the mobile device 200.

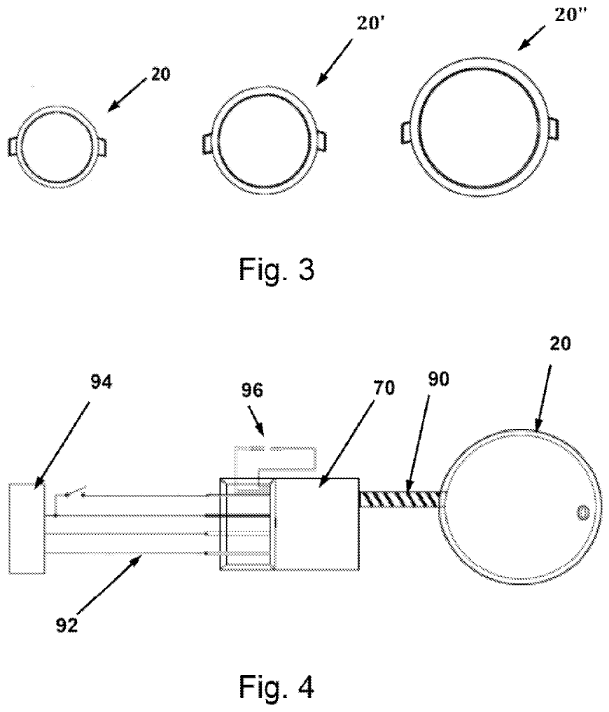

FIG. 3 is a bottom plan view showing various sizes of the light housing of the emergency lighting system. Examples shown are 4″ down light with emergency battery backup 20, 6″ down light with emergency battery backup 20′ and 8″ down light with emergency battery backup 20″. FIG. 4 shows a typical wiring layout for the emergency lighting system;

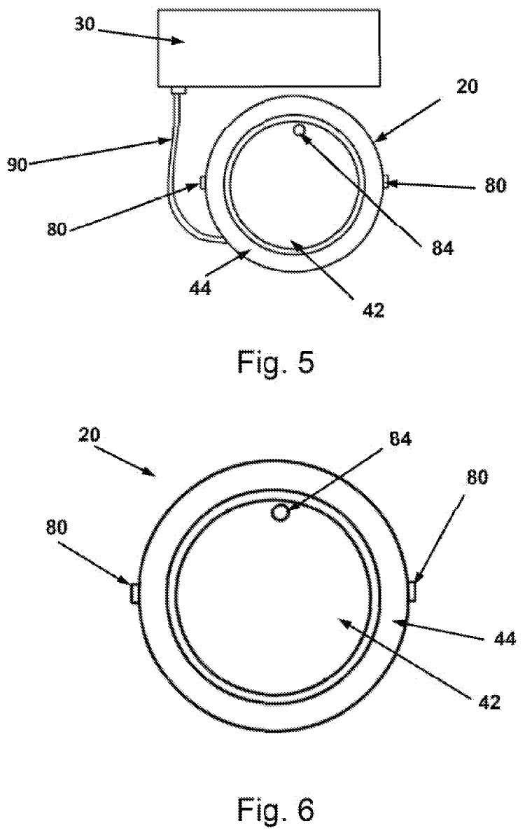

FIG. 5 shows a bottom plan view of the emergency lighting system and FIG. 6 is a bottom plan view of the visible portion of the emergency lighting system. When power is supplied to the LED lamp from the control circuit an area is illuminated below the emergency lighting fixture. The LED indicator may be on when the EBBU (Emergency Battery Backup Unit) mode is activated. If AC power to the EBBU (Emergency Battery Backup Unit) Unit is disconnected or fails for any reason, the LED lamp will continue to operate on battery power and may automatically adjust its output level to an emergency power-saving mode to ensure operation for a specific amount of time.

Once the AC power is restored to the EBBU, the control system will charge and then maintain the emergency battery for best performance. The LED indicator may flicker slowly when the battery in charging and may flicker quickly when an EBBU (Emergency Battery Backup Unit) error occurs. Depressing the test button may activate the EBBU (Emergency Battery Backup Unit) mode while releasing the test button may revert the mode to AC. The emergency lighting fixture may include a dimmer for reducing the power supplied to the LED lamp. The LED lamp may provide at least 1000 lumens. The emergency lighting fixture may be ETL and ES certified. Power into the LED lamp may be between 5 watts and 30 watts and preferably between 10 watts and 18 watts. The LED lamp color may be between 22K and 60K and preferably between 27K and 50K. The light housing may be constructed of die-cast aluminum. The emergency lighting fixture according to claim 1 wherein the wattage of the LED lamp is tunable. The emergency lighting fixture 10 may include a switch to turn on the LED lamp 40 without initiating the battery backup.

In another aspect of the present invention, FIG. 5 shows a method of installing the emergency lighting fixture. The method includes providing a light housing 20 having reflective surfaces for providing light in a generally downward direction, the housing mountable to a ceiling surface 50 having low clearance, the emergency lighting fixture including an LED lamp 40 disposed in the light housing 20, a control box 30 movable with respect to the light housing 20, a battery 60, a control circuit 70 disposed in the control box 30 for controlling power flow through the battery 60 and the power flow through the LED lamp 40, a wire harness or cable 90 electrically connecting the LED lamp 40 through the light housing 20 to the control box 30, an LED indicator 80 on a bottom surface of the light housing 20 and a test button disposed on the bottom surface of the light housing wherein power is stored in the battery 60 and the battery is in constant electrical connection to the control circuit and wherein when power is supplied to the LED lamp from the control circuit an area is illuminated below the emergency lighting fixture. The method includes providing an opening in a ceiling where the emergency lighting system is to be installed, wiring a power cable to the emergency lighting system control box, placing the control box in above the ceiling and mounting the light housing in the ceiling opening.

The slim LED down light with integrated emergency battery and push button indicator is pre-wired, easier to install and decoratively appealing.

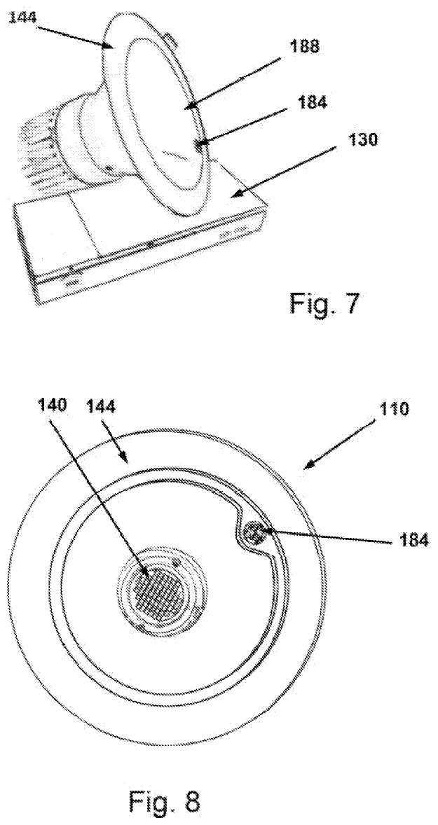

FIGS. 7-10 show a second embodiment of emergency lighting system, the light housing 120 having a higher profile than the light housing 20 described above.

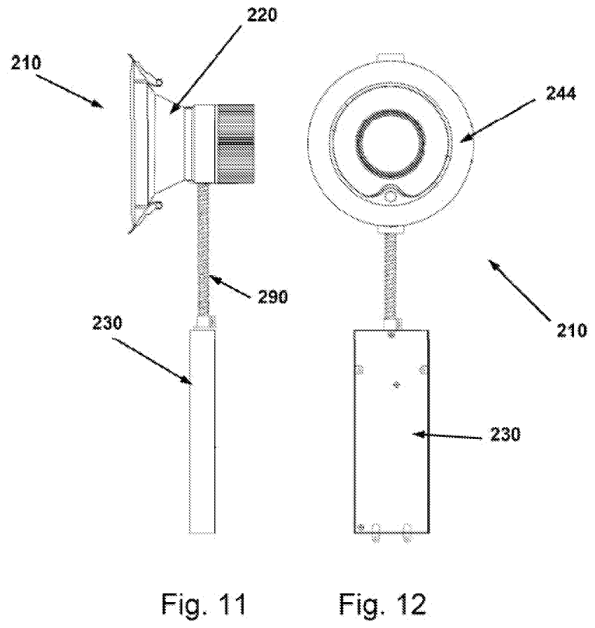

FIG. 11 shows a side elevational view of another embodiment of the emergency lighting system, the light housing 220 having a different light housing than both the light housing 20 and light housing 120. FIG. 12 is a bottom plan view of the emergency lighting system shown in FIG. 11.

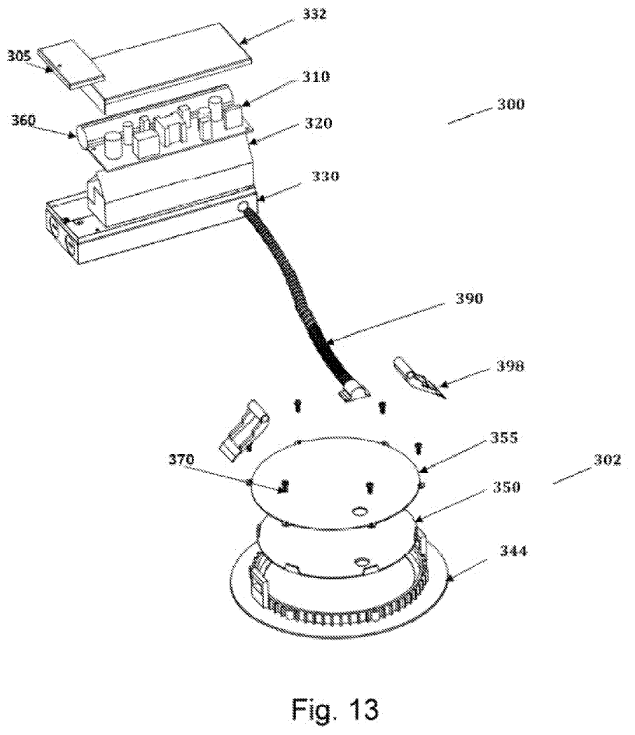

FIG. 13 is a perspective view of yet another embodiment of the emergency lighting system according to the present invention. There is shown, according to the present invention, the emergency lighting fixture 300. The emergency lighting fixture 300 includes a control box 330 and a light housing 302 having reflective surfaces for providing light in a generally downward direction, the light housing 302 mountable to a ceiling surface 50, preferable mounted in an opening 52 of the ceiling. The light housing 302 is particularly useful in ceilings having low clearance in the space above the ceiling. The emergency lighting fixture 300 includes an LED lamp 355 which may be an LED mounted on a circuit board disposed in the light housing 303, the control box 330 movable with respect to the light housing 302, a battery 360 and a control circuit 310 disposed in the control box 330 for controlling power flow through the battery 360 and the power flow through the LED lamp 355. The battery 360 may alternately be located in the light housing 302. The emergency lighting fixture 300 includes a cable or wire harness 390 electrically connecting the LED lamp 355 through the light housing 302 to the control box 330. The emergency lighting fixture 300 includes at least one LED indicator adjacent or on a lens 350 of the light housing 302, the cable 390 electrically connects a circuit 310 in the control box 330 and the LED lamp 355 in the light housing 302. The emergency lighting fixture 300 includes a test button disposed on the bottom surface of the light housing 302 or adjacent the lens 350 or outer ring 344. Power is stored in the battery 360 and the battery 360 is in constant electrical connection to the control circuit 310. The emergency lighting fixture 300 includes a circuit cover 305 for covering the circuit 310 and a control box cover 332 for covering the control box 330. Insulation 320 electrically isolates the control circuit 310 from the control box 330 and control box cover 332. Fasteners 370 secure the LED 355 to the lens 350. Installation fasteners 398 secure the light housing 302 to the opening in the ceiling.

The exiting emergency down light fixture is composed emergency battery back and down light fixture. This invention is to alleviate this pain and simplify the installation with simple instruction to save time and save labor. The present invention is an LED ultra slim down light with pre-wired battery and emergency push button indicator and may include full metal conduit wiring and combine LED driver and battery backup driver metal housing box.

The present invention is a down light with integrated emergency battery backup and push button indicator with combining driver and battery pack in metal housing. The emergency down light is used in commercial building, hospital, school, office and residential housing. This invention is more decorative than current emergency lighting fixtures. This invention has a lighting function and an emergency lighting function in one fixture. Saving additional labor installation and material cost. The emergency lighting fixture combines compatible battery pack and LED lighting fixture during installation to set up this type of system.

The emergency lighting fixture combines compatible battery pack and down light fixture to create an emergency lighting fixture. The emergency down light includes a pre-wired battery and down light fixture combine in one housing. The housing may be metal or other material such as heat-resistant plastic or composite material. The emergency light fixture may save on labor costs in drilling an additional hole in the ceiling to house the push button by including the push button indicator pre-wired into the fixture which saves on overall installation time.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A intelligent lighting fixture, comprising:
a light housing having reflective surfaces for providing light in a generally downward direction, the light housing mountable to a ceiling surface having a low clearance above the ceiling surface;
an LED lamp disposed in the light housing;
a control box movable with respect to the light housing;
a battery disposed in the control box;
a control circuit disposed in the control box for controlling power flow through the battery and the power flow through the LED lamp;
a wire harness electrically connecting the LED lamp through the light housing to the control box;
wherein power is stored in the battery and the battery is in constant electrical connection to the control circuit; and
wherein when power is supplied to the LED lamp from the control circuit, an area is illuminated below the emergency lighting fixture;
a sensor configured to trigger lighting functions;
a control circuit for lighting functions and control functions; and
a smart BLE (Bluetooth Low Energy) control sensor system integrated into the control circuit;
wherein the control circuit is accessible from a mobile device.

2. The intelligent lighting fixture of claim 1, wherein the smart BLE control sensor system is configured to communicate with the mobile device through a mobile application.

3. The intelligent lighting fixture of claim 2, wherein the mobile application is configured to control the lighting functions and control functions of the fixture.

4. The intelligent lighting fixture of claim 1, wherein the sensor is a motion sensor configured to trigger the lighting functions based on detected motion.

5. The intelligent lighting fixture of claim 1, wherein the control circuit is programmable to customize the lighting functions and control functions.

6. The intelligent lighting fixture of claim 1, including an emergency battery backup system configured to automatically power the LED in the event of a power outage.

7. The intelligent lighting fixture of claim 6, wherein the emergency battery backup is rechargeable.

8. An intelligent lighting fixture, comprising:
a smart BLE (Bluetooth Low Energy) control sensor system;
a sensor configured to trigger various functions;
a control circuit for lighting functions and control functions;
an emergency battery backup; and
a phone app configured to program or access the control circuit.

9. The intelligent lighting fixture of claim 8, wherein the smart BLE control sensor system is configured to communicate with the phone app to control the lighting functions and control functions of the fixture.

10. The intelligent lighting fixture of claim 9, wherein the phone app is configured to receive sensor data from the sensor and adjust the lighting functions and control functions based on the received sensor data.

11. The intelligent lighting fixture of claim 10, wherein the sensor is a motion sensor configured to trigger the lighting functions based on detected motion.

12. The intelligent lighting fixture of claim 11, wherein the control circuit is programmable via the phone app to customize the lighting functions and control functions.

13. The intelligent lighting fixture of claim 12, wherein the emergency battery backup is configured to automatically power the fixture in the event of a power outage and the status of the emergency battery backup is communicated to the phone app.

14. An emergency downlight lighting fixture, comprising:
a smart BLE (Bluetooth Low Energy) control system;
a sensor configured to trigger at least one function;
a control circuit for lighting control; and
an emergency battery backup.

15. The emergency downlight lighting fixture of claim 14 wherein the smart BLE control sensor system is configured to communicate with a mobile application.

16. The emergency downlight lighting fixture of claim 15 wherein the mobile application is configured to control the lighting functions of the fixture.

17. The emergency downlight lighting fixture of claim 14 wherein the sensor is a motion sensor configured to trigger the lighting functions based on detected motion.

18. The emergency downlight lighting fixture of claim 14, wherein the control circuit is programmable to customize the lighting functions.

19. The emergency downlight lighting fixture of claim 14, wherein the emergency battery backup is configured to automatically power the fixture in the event of a power outage.

20. The emergency downlight lighting fixture of claim 19, wherein the emergency battery backup is rechargeable.
